(19) United States
(12) Patent Application Publication
(10) Pub. No.: US 2006/0234573 A1
(43) Pub. Date: Oct. 19, 2006

(54) Chemical protective fabric

(76) Inventor: Moshe Rock, Brookline, MA (US)

Correspondence Address: FISH & RICHARDSON PC, P.O. BOX 1022, MINNEAPOLIS, MN, 55440-1022, US

(21) Appl. No.: 11/269,040

(22) Filed: Nov. 8, 2005

Related U.S. Application Data
(60) Provisional application No. 60/628,518, filed on Nov. 16, 2004.

(51) Int. Cl. B32B 5/02; B32B 27/04; D04H 1/00

(52) U.S. Cl. 442/59; 428/299.1; 442/414

(57) ABSTRACT

A chemical protective fabric garment system consists of a knit thermal fabric layer formed of synthetic yarns or fibers with embedded particles of activated carbon and an inner knit layer formed of one or more yarns made of fibers carrying activated carbon particles. The first knit thermal fabric layer has at least one raised surface with a large surface area and high three-dimensional bulk. The inner knit layer has an inner surface, towards a wearer's skin, brushed for increased surface area to provide enhanced absorption and reduced touching points upon the skin.

### TECHNICAL FIELD

This application claims benefit from U.S. Provisional Patent Application No. 60/628,518, filed Nov. 16, 2004, now pending.

This disclosure relates to protective fabrics, and to protective garments incorporating such fabrics, and, more particularly, to chemical protective fabrics and chemical protective fabric garments.

### BACKGROUND

Currently, many military, homeland security, and first responder personnel are equipped with chemical protective cloth garments provided under the SARATOGA® brand, owned by Blucher GmbH, of Dusseldorf, Germany. In one implementation, the SARATOGA chemical protective clothing system consists of a heavy, woven outer shell, formed of cotton or a cotton/nylon mix that is liquid repellent, worn over an intermediate liner consisting of a filter material formed of a breathable membrane, e.g. a nonwoven cloth, disposed atop an inner textile carrier containing activated carbon absorber. The breathable membrane, which has selective impermeability to chemical agents in a form of vapor and/or liquid, is constructed to permit limited moisture vapor transmission, but it also generates high levels of heat stress during periods of high activity by the wearer. The activated carbon absorbers used in the SARATOGA system are incorporated into fibers of the textile carrier, or, in other implementations, spherical activated carbon absorbers are adhered to the textile carrier with an adhesive binder or resin.

### SUMMARY

According to the disclosure, a chemical protective fabric garment system comprises a knit thermal fabric layer formed of synthetic yarns or fibers with embedded particles of activated carbon, the first knit thermal fabric layer having at least one raised surface with a large surface area and high three-dimensional bulk; and an inner knit layer formed of one or more yarns made of fibers carrying activated carbon particles and having an inner surface, towards a wearer's skin, brushed for increased surface area to provide enhanced absorption and reduced touching points upon the skin.

Preferred implementations may include one or more of the following additional features. The inner knit layer has a knitting construction selected from the group consisting of single jersey, plaited jersey, double knit, rib terry, and triple plaited terry. The inner fabric layer has one or more properties selected from the group consisting of good water management, good stretch recovery, and kindness to a wearer's skin. The inner fabric layer is formed of materials with flame retarding properties. Preferably, the inner fabric layer has enhanced flame retarding properties provided, at least in part, by activated carbon particles embedded in fibers of the inner fabric layer. The inner fabric layer has high absorption performance for hazardous chemicals including in the form of gas, vapor, mist, or liquid. The knit thermal fabric layer includes fibers comprising synthetic material selected from the group consisting of acrylic, acrylonitrile, nylon, and polyester. The knit thermal fabric layer is formed by a knitting process selected from the group consisting of circular knit and warp knit. The knit thermal fabric layer is formed by the process of circular knitting and has a knitting construction selected from the group consisting of terry, terry sliver knit in regular plaiting, terry sliver knit in reverse plaiting, and sliver knit. The knit thermal fabric layer has a knitting construction selected from the group consisting of regular plaiting and reverse plaiting, and one or both surfaces are physically brushed or raised by napping, brushing or sanding. The knit thermal fabric layer has one or both surfaces finished with fleece, velour or shearling. The knit thermal fabric layer is in stand-alone or laminated form. The knit thermal fabric layer has a large surface area and high three-dimensional bulk. The knit thermal fabric layer is single face or double face. The knit thermal fabric layer defines air flow paths of high tortuosity, which, combined with Brownian movement of hazardous chemical molecules, ensures suitably high probability of contact by hazardous chemical molecules with activated carbon particles embedded in and upon fibers. Activated carbon particles are embedded in and upon one or more of stitch yarn, terry yarn and loop yarn. The knit thermal fabric layer further comprises elastomeric fibers in stitch yarn of regular plait and reverse plait constructions. The knit thermal fabric layer is formed by warp knit, with single face or double face knit or double needle bar construction. The chemical protective fabric garment system further comprises an outer protective fabric shell. The inner knit layer also has an outer surface brushed for increased surface area and for increased tortuosity of the inner knit layer.

The details of one or more implementations are set forth in the accompanying drawings and the description below. Other features, objects, and advantages will be apparent from the description and drawings, and from the claims.

### DESCRIPTION OF DRAWINGS

FIG. 1. is a somewhat diagrammatic view of a first responder garbed in a chemical protective fabric garment system.

FIG. 2 is an exploded side section view of a chemical protective fabric.

Like reference symbols in the various drawings indicate like elements.

### DETAILED DESCRIPTION

The chemical protective safety fabric garment system further enhances safety with extra protection for the wearer, especially when the outer shell protective garment is bridged, e.g. when the fabric is torn, fails to fully cover the wearer, when there is a low saturation level of the activated carbon, or when the protective shell garment is saturated, with little or no additional capacity for absorption. Redundancy of protective layers and high comfort level are crucial in the present disclosure.

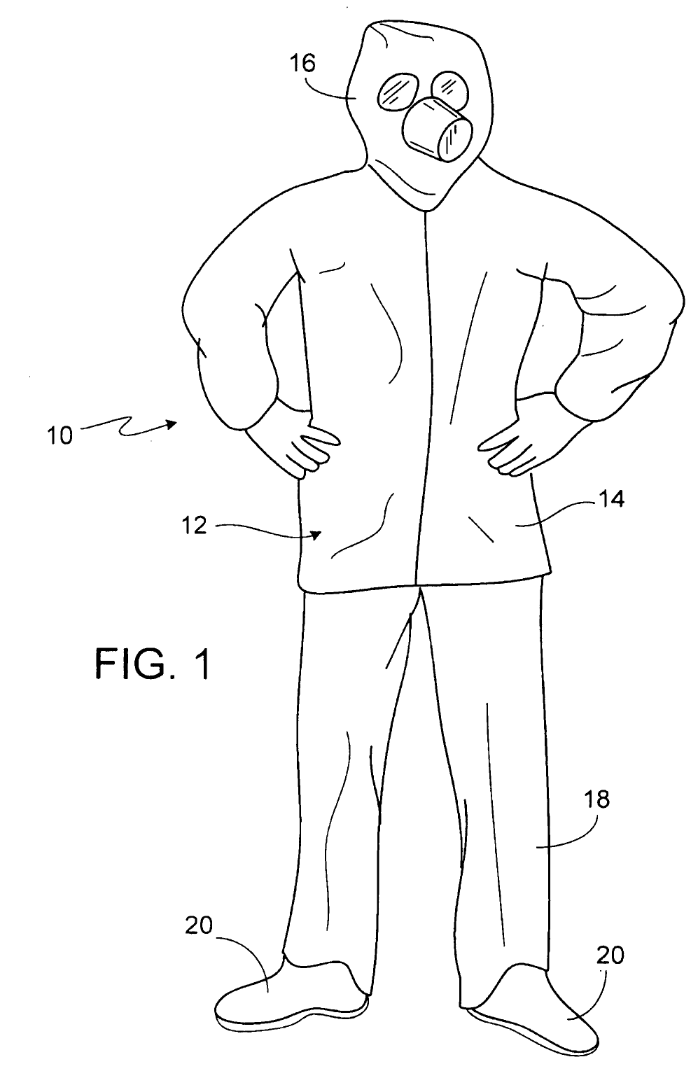

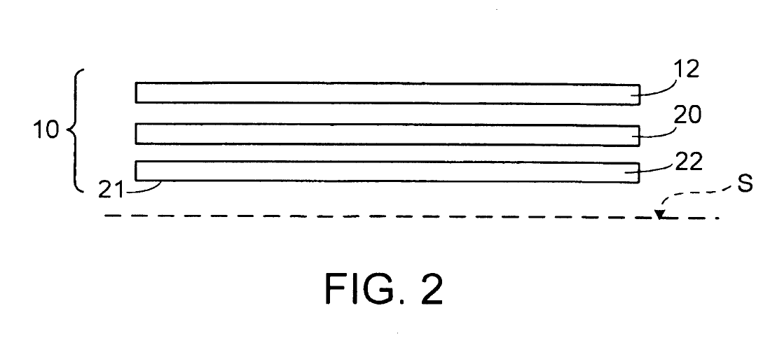

Referring to FIGS. 1 and 2, a chemical protective fabric garment system 10 consists of an outer fabric shell 12, typically including a zippered, upper garment portion 14 (with an integral hood 16) and a lower garment portion 18 (extending over the uppers of the wearer's boots 20); an intermediate thermal fabric layer 20; and a first, inner fabric layer 22, all now to be described in more detail.

Outer Fabric Shell (12)

As described above, the outer shell 12 is typically constructed of a heavy, woven fabric formed, for example, of cotton or a cotton/nylon mix, e.g. as available from Tex-Shield, Inc., of Washington, DC, as SARATOGA® permeable chemical protective clothing and fabric, or a woven fabric laminated to a selectively permeable membrane (“SPM”). The shell is designed to be repellent to liquid, including hazardous chemicals in liquid state or in a liquid carrier.

Thermal (Intermediate) Fabric Layer (20)

In the intermediate thermal fabric layer 20, activated carbon particles are imbedded in synthetic fibers, formed, e.g., of acrylic, acrylonitrile, nylon, polyester, or other suitable material, which are spun to a textile yarn and knitted in circular knit or warp knit. In the case of circular knit, the preferred fabric construction is typically selected from among, e.g., single jersey, plaited jersey, triple plaited jersey, double knit, rib terry, terry loop in regular plaiting or reverse plaiting, and sliver knit (as described below). Terry loop fabric in regular plaiting or reverse plaiting knit construction is physically finished to form a raised surface, e.g., by napping, brushing, or sanding. The raised surface, which can be finished as fleece, velour, shearling, and may be in the form of a stand alone fabric or a laminated fabric, will have a large surface area (i.e., the sum total of the surface areas of the fibers forming the volume of the raised surface) and relatively high three-dimensional bulk.

These properties, preferably found in a fabric constructed to have high tortuosity of passageways through the fabric, combine to retard and thwart passage of hazardous chemicals through the fabric. Molecules, including molecules of hazardous chemical, in colloidal suspension are subject to “Brownian” movement (i.e. rapid movement, not in a straight line, but with irregular, rapid, random motion). The bulky, raised-surface thermal fabric layer of the protective fabric (which has relatively higher bulk with lower weight, i.e., as common to THERMALPRO® fabric and WINDPRO® fabric in the POLARTEC® fleece fabric product line manufactured and distributed by Malden Mills Industries, Inc., of Lawrence, Mass., assignee of the present disclosure) resists penetration of hazardous chemical through the fabric. In particular, the high bulk-to-weight ratio, and the large surface area of the raised surface fleece, combines with the Brownian movement to ensure a high rate of absorption of the hazardous chemicals (gas, aerosol, vapor, mist or liquid) by the activated carbon particles imbedded in the fibers and on the fiber surfaces, as the narrow passageways serve to ensure that the Brownian movement of the molecules brings the hazardous chemicals into contact with the particles of activated carbon. The raised surface fabric, in single face or double face, serves also as a thermal insulation layer in cold weather conditions. This thermal insulation fabric layer 20, with enhanced tortuosity property, can be made of 100% synthetic fiber yarn containing activated carbon particles, e.g. in the sinker loop yarn and the stitch yarn, or in just the sinker loop yarn, or in just the terry yarn. All of these yarns will be raised by napping, and preferably will have relatively finer denier for increased tortuosity of passageways through the fabric layer, and increased surface area for better absorption by the activated carbon particle. The stitch yarn, which is not raised, can be made of other synthetic yarn or of natural or regenerated yarn. This knit construction may also contain elastomeric yarn in the stitch yarn where the fabric is formed of plaited or reverse plaiting construction.

Alternatively, in another implementation, the intermediate thermal fabric layer 20 may be formed with warp knit construction having high bulk-to-weight ratio in single face or double face, knitted on a double needle bar, e.g. as described in U.S. Pat. No. 5,855,125, the complete disclosure of which is incorporate herein by reference.

In yet another implementation, the fabric layer 20 may be formed with sliver knit construction having high bulk-to-weight ratio. (Sliver knit is a high loft, knit fabric, e.g. resembling initiation fur, created by locking individual fibers directly into a lightweight knit backing to permit each fiber to stand upright, free from the backing).

First (Inner) Fabric Layer (22)

A first layer garment 22, worn beneath the thermal layer 20, closer to the wearer's skin, S, is important in the layering system for further improving the redundancy of protection.

The first layer garment 22 consists of a fabric formed as a knit textile fabric, e.g. as a single jersey, plaited jersey, double knit, or rib, with or without spandex stretch yarn, where one component yarn, and/or all component yarns, are made of fibers containing activated carbon particles. The first layer will preferably still have other comfort properties, e.g. good water management, good stretch recovery, and/or kindness to the wearer's skin, while having high absorption affinity for hazardous chemicals, e.g. in gaseous, vaporous or mist, or liquid state. The inner side 21 of the textile knit fabric, i.e. as a first layer next to the wearer's skin, is brushed to reduce the touching points to the skin and to increase its surface area for enhanced absorption of hazardous chemicals. In other implementations, the textile knit fabric may be brushed on both surfaces to further increase the surface area, and to increase tortuosity of passageways through the fabric layer. As described above, yarns of relatively finer denier are preferred. The imbedded activated carbon particles will also enhance the flame-retarding performance of the yarn, especially where the material forming the yarn has some degree of flame-retarding ability.

A number implementations have been described. Nevertheless, it will be understood that various modifications may be made without departing from the spirit and scope of the disclosure. Accordingly, other implementations are within the scope of the following claims.

1. A chemical protective fabric garment system, comprising:
a knit thermal fabric layer formed of synthetic yarns or fibers with embedded particles of activated carbon, the first knit thermal fabric layer having at least one raised surface with a large surface area and enhanced three-dimensional bulk; and
an inner knit layer formed of one or more yarns made of fibers carrying activated carbon particles and having an inner surface, towards a wearer's skin, brushed for increased surface area to provide enhanced absorption and reduced touching points upon the skin.

2. The chemical protective fabric garment system of claim 1, wherein the inner knit layer has a knitting construction selected from the group consisting of single jersey, plaited jersey, double knit, rib terry, and triple plaited terry.

3. The chemical protective fabric garment system of claim 1 or claim 2, wherein the inner fabric layer has one or more properties selected from the group consisting of: good water management, good stretch recovery, and kindness to a wearer's skin.

4. The chemical protective fabric garment system of claim 1, wherein the inner fabric layer is formed of materials with flame retarding properties.

5. The chemical protective fabric garment system of claim 4, wherein the inner fabric layer has enhanced flame retarding properties provided, at least in part, by activated carbon particles embedded in fibers of the inner fabric layer.

6. The chemical protective fabric garment system of claim 1, wherein the inner fabric layer has high absorption performance for hazardous chemicals including in the form of gas, vapor, mist, or liquid.

7. The chemical protective fabric garment system of claim 1, wherein the knit thermal fabric layer includes fibers comprising synthetic material selected from the group consisting of: acrylic, acrylonitrile, nylon, and polyester.

8. The chemical protective fabric garment system claim 1, wherein the knit thermal fabric layer is formed by a knitting process selected from the group consisting of: circular knit and warp knit.

9. The chemical protective fabric garment system of claim 1, wherein the knit thermal fabric layer is formed by the process of circular knitting and has a knitting construction selected from the group consisting of: terry, terry sliver knit in regular plaiting, terry sliver knit in reverse plaiting, and sliver knit.

10. The chemical protective fabric garment system of claim 1, wherein the knit thermal fabric layer has a knitting construction selected from the group consisting of regular plaiting and reverse plaiting, and one or both surfaces are physically brushed or raised by napping, brushing or sanding.

11. The chemical protective fabric garment system of claim 1, wherein the knit thermal fabric layer has one or both surfaces brushed or raised to form fleece, velour or shearling.

12. The chemical protective fabric garment system of claim 1, wherein the knit thermal fabric layer is in stand-alone or laminated form.

13. The chemical protective fabric garment system of claim 1, wherein the knit thermal fabric layer has a large surface area and enhanced three-dimensional bulk.

14. The chemical protective fabric garment system of claim 1, wherein the knit thermal fabric layer is single face or double face.

15. The chemical protective fabric garment system of claim 1, wherein the knit thermal fabric layer defines air flow paths of high tortuosity, which, combined with Brownian movement of hazardous chemical molecules, ensures suitably high probability of contact by hazardous chemical molecules with activated carbon particles embedded in and upon fibers.

16. The chemical protective fabric garment system of claim 15, wherein activated carbon particles are embedded in and upon one or more of: stitch yarn, terry yarn and loop yarn.

17. The chemical protective fabric garment system of claim 1, wherein the knit thermal fabric layer further comprises elastomeric fibers in stitch yarn of regular plait and reverse plait constructions.

18. The chemical protective fabric garment system of claim 1, wherein the knit thermal fabric layer is formed by warp knit, with single face or double face knit or double needle bar construction.

19. The chemical protective fabric garment system of claim 1, further comprising an outer protective fabric shell.

20. The chemical protective fabric garment system of claim 1, wherein said inner knit layer also has an outer surface brushed for increased surface area and for increased tortuosity of said inner knit layer.
